(19) United States
(12) Patent Application Publication
(10) Pub. No.: US 2024/0106573 A1
(43) Pub. Date: Mar. 28, 2024

(54) CODE BLOCK GROUP BOUNDARY AND MAC SUBHEADER ALIGNMENT

(71) Applicant: Apple Inc., Cupertino, CA (US)

(72) Inventors: Panagiotis Botsinis, Munich (DE); Amr Abdelrahman Yousef Abdelrahman Mostafa, Munich (DE); Christian Hofmann, Munich (DE); Sameh M. Eldessoki, Munich (DE); Tarik Tabet, Carlsbad, CA (US)

(21) Appl. No.: 18/369,086

(22) Filed: Sep. 15, 2023

(30) Foreign Application Priority Data
Sep. 23, 2022 (GR) 20220100784

(51) Int. Cl. H04L 1/1812; H04L 1/00; H04W 72/231

(52) U.S. Cl. CPC H04L 1/1812; H04L 1/0008; H04W 72/231; H04W 80/02

(57) ABSTRACT

Systems and methods are for receiving, from a transmitter, a transport block comprising medium access control (MAC) subheader fields and data units, the transport block being divided into code block groups, a beginning of each code block group in the transport block comprising an alignment with a beginning of a respective MAC subheader field in the transport block; and based on the alignment, decoding the code block groups of the transport block.

### CLAIM OF PRIORITY

This application claims priority under 35 U.S.C. § 119(b) to Greek Patent Application No. 20220100784, filed on Sep. 23, 2022, the entire contents of which are hereby incorporated by reference.

### BACKGROUND

Wireless communication networks provide integrated communication platforms and telecommunication services to wireless user devices. Example telecommunication services include telephony, data (e.g., voice, audio, and/or video data), messaging, internet-access, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include code division multiple access (CDMA) networks, time division multiple access (TDMA) networks, frequency-division multiple access (FDMA) networks, orthogonal frequency-division multiple access (OFDMA) networks, Long Term Evolution (LTE), and Fifth Generation New Radio (5G NR). The wireless communication networks facilitate mobile broadband service using technologies such as OFDM, multiple input multiple output (MIMO), advanced channel coding, massive MIMO, beamforming, and/or other features.

### SUMMARY

This specification describes configurations for the MAC and PHY layers of a 5G NR protocol stack. Specifically, this specification describes different procedures and configurations for alignment of medium access control (MAC) sub-headers and corresponding code block groups (CBGs). The configurations and procedures enable a receiver, such as user equipment (UE), to predict where packet boundaries are in a transmission if the receiver fails to decode one or more code blocks (CBs) sent by a transmitter, such as a base station (e.g., a next generation node gNB). In some implementations, CBGs are disabled, and the CBs are ungrouped.

MAC control elements (CEs) are associated with the MAC layer. MAC service data units (SDUs) are the output of the transmitter RLC layer and are used as inputs to the MAC layer. The MAC layer orders the MAC SDUs in the TB. CBGs are associated with the PHY layer. CBs are associated with the PHY layer.

The MAC sublayer includes a logical channel identifier (LCID) field. The MAC sublayer includes MAC SDU instances. The MAC sublayer includes MAC control elements (CEs). In some implementations, the MAC sublayer includes padding. The LCID field identifies logical channel instances of a corresponding MAC SDU, a type of corresponding MAC CE, or padding present in the MAC sublayer. The MAC CE is a MAC structure that carries control information for both downlink (DL) and uplink (UL) scenarios. A list of example MAC CEs and their corresponding LCIDs is defined further in 3 GPP TS 38.321 (e.g., Table 6.2.1-1 and Table 6.2.1-2 in Rel. 15 6.2.1).

A receiver is configured to decode the CBs of the CBGs. When a CBG is decoded, the data is forwarded to higher layers in the protocol stack. If a portion of a CBG is not decoded, the receiver requests a retransmission of the CBG. For example, in legacy systems, if a Hybrid Automatic Repeat Request (HARQ) process operates on a CBG level, and one of the CBGs is negatively acknowledged (NACKed), then the HARQ process does not forward the correctly decoded parts of the MAC SDU to the RLC. Instead, the HARQ process waits for HARQ retransmission, which is until the whole transport block (TB) is correctly decoded. Once this occurs, the decoded CBGs are forwarded to the higher layers.

In legacy systems, the receiver waits to decode the entire TB before forwarding any CBGs to the higher layers because the receiver has no data that maps a CB or CBG to a specific MAC PDU. The receiver, therefore, has no prior knowledge of where CB or CBG boundaries are in the transmission. In legacy systems, the TB includes the concatenated MAC CEs, MAC headers, and MAC SDUs. The TB is split into code blocks independently from consideration of the MAC PDU borders.

A size of each code block is defined in the 3GPP specification. CB length values are optimized for low density parity check (LDPC) decoding. The size of the code blocks depends on respective channel coding to be selected for 6^{th} generation (6G) networks. When a CB is NACKed in legacy systems, the receiver does not have data specifying packet boundaries that exist after that NACKed CB. Any potentially decoded CBs after the NACK'ed CB cannot be used by the receiver or forwarded to higher layers.

To overcome these issues, the systems and processes described herein are configured to align CBGs of the PHY layers and MAC SDUs or MAC CEs of the MAC layer. Alignment of fields of the MAC sublayer and the CBGs of the PHY layer enables the receiver to determine or predict where each CBG boundary is located within a transmission. When a receiver fails to decode a code block, the receiver can still determine where the boundary of the next CBG begins. The receiver (e.g., a UE) can use data from subsequent CBGs that are successfully decoded and that occur after a CB that is not successfully decoded. The receiver can forward the data from the decoded CBs to higher layers in the protocol stack in parallel with a Hybrid Automatic Repeat Request (HARQ) retransmission. The higher layers can begin using the data from decoded CBGs while the HARQ retransmission is still occurring.

The systems and methods described herein provide one or more of the following advantages. The receiver has prior knowledge of the boundaries of CBs or CBGs in the TB. When the receiver fails to decode a CB, the receiver can still decode subsequent CBs and send data from these CBs to higher layers. The receiver can forward decoded CBs either prior to or in parallel with the HARQ retransmission procedure. For example, the receiver can immediately forward correctly decoded CBGs or CBs to portions of the RLC layer, the packet data convergence protocol (PDCP) layer, or Service Data Adaption Protocol (SDAP) layer, without waiting for the retransmission of the NACKed CBGs.

The receiver can reduce data latencies for the decoded CBs by immediately forwarding them to the higher layers in the protocol stack. The receiver can initiate a pipelined processing workflow for CBs with a reduced delay that would occur if the entire TB were decoded before initiating the workflow. For example, each positively acknowledged (ACKed) CBG is passed directly to the MAC and potentially RLC layer if it includes a complete MAC SDU. Each CBG may resemble a complete MAC subPDU. The RLC layer performs RLC segments reassembly, if needed. The RLC layer can reassemble the RLC SDU without a complete reception of the TB. The RLC SDU can be forwarded to PDCP without a complete reception of all CBGs. If no reordering is needed on PDCP level after decoding, the CBGs or CBs are passed to the SDAP layer that performs quality of service (QoS) mapping and forwards the mapping to higher layers. The higher layers can immediately be processing the CBs and subsequently generated data, rather than wait for the whole TB to be successfully decoded. The upper layers process parts of the TB (e.g., successfully decoded CBGs), thereby avoiding processing peaks.

The details of one or more embodiments of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, in accordance with some embodiments.

FIG. 2 is a block diagram that illustrates contents of the MAC layer.

FIG. 3 is a block diagram that illustrates a MAC and PHY layer data configuration including non-aligned MAC sub-headers and CBs.

FIG. 4 is a block diagram that illustrates a MAC and PHY layer data configuration including CBGs aligned with MAC sub-headers and MAC CEs mapped to a start of the transport block.

FIG. 5 is a block diagram that illustrates a MAC and PHY layer data configuration including CBGs having variable numbers of CBs and being aligned with MAC sub-headers and MAC CEs mapped to a start of the transport block.

FIG. 6 is a block diagram that illustrates a MAC and PHY layer data configuration including CBGs being aligned with MAC sub-headers and interspersed MAC CEs.

FIG. 7 is a block diagram that illustrates a MAC and PHY layer data configuration including CBGs having variable numbers of CBs and being aligned with MAC sub-headers and having interspersed MAC CEs.

FIG. 8 is a block diagram that illustrates a MAC and PHY layer data configuration including CBGs being aligned with MAC sub-headers and a CBG mode bitmap.

FIG. 9 is a block diagram that illustrates a MAC and PHY layer data configuration including CBGs being aligned with MAC sub-headers and a CBG mode per CBG in the MAC sub-header.

FIG. 10A illustrates a process for communicating in a wireless network using CBGs aligned with MAC sub-headers.

FIG. 10B illustrates a process for communicating in a wireless network using CBGs aligned with MAC sub-headers.

FIG. 11 illustrates a user equipment (UE), in accordance with some embodiments.

FIG. 12 illustrates an access node, in accordance with some embodiments.

### DETAILED DESCRIPTION

This specification describes configurations for a transport block for the MAC and PHY layers of a 5G NR protocol stack. Specifically, this specification describes different procedures and configurations for alignment of medium access control (MAC) sub-headers and corresponding code block groups (CBGs). The configurations and procedures enable a receiver, such as user equipment (UE), to predict where packet boundaries are in a transmission if the receiver fails to decode one or more code blocks (CBs) sent by a transmitter, such as a base station (e.g., a next generation node gNB).

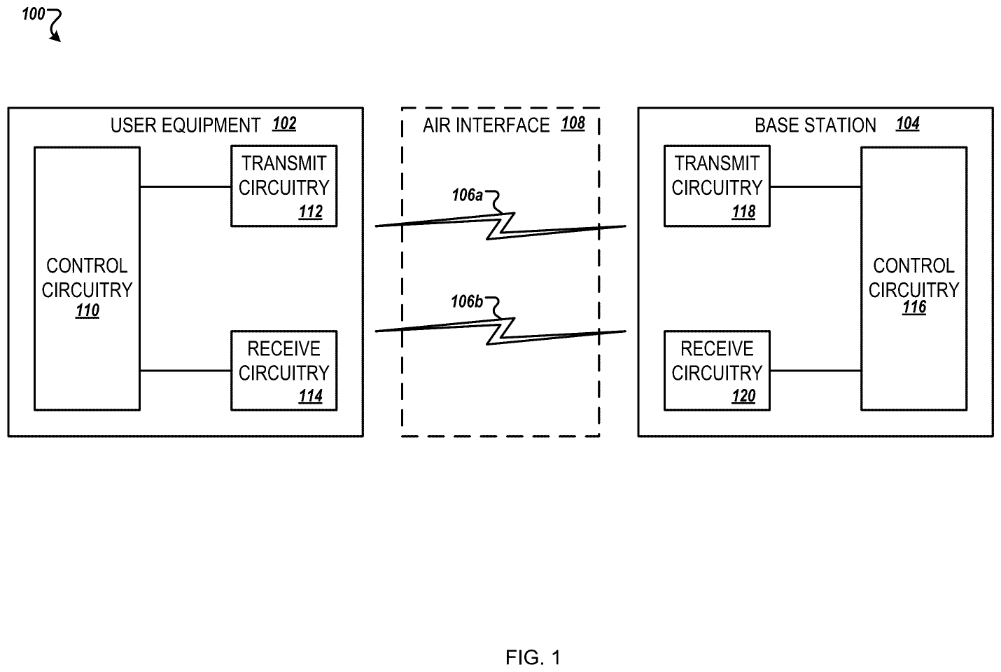

FIG. 1 illustrates a wireless network 100, in accordance with some embodiments. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

For purposes of convenience and without limitation, the wireless network 100 is described in the context of Long Term Evolution (LTE) and Fifth Generation (5G) New Radio (NR) communication standards as defined by the Third Generation Partnership Project (3GPP) technical specifications. More specifically, the wireless network 100 is described in the context of a Non-Standalone (NSA) networks that incorporate both LTE and NR, for example, E-UTRA (Evolved Universal Terrestrial Radio Access)-NR Dual Connectivity (EN-DC) networks, and NE-DC networks. However, the wireless network 100 may also be a Standalone (SA) network that incorporates only NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare monitoring, remote security surveillance systems, intelligent transportation systems, or any other wireless devices with or without a user interface. In network 100, the base station 104 provides the UE 102 network connectivity to a broader network (not shown). This UE 102 connectivity is provided via the air interface 108 in a base station service area provided by the base station 104. In some embodiments, such a broader network may be a wide area network operated by a cellular network provider or may be the Internet. Each base station service area associated with the base station 104 is supported by antennas integrated with the base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

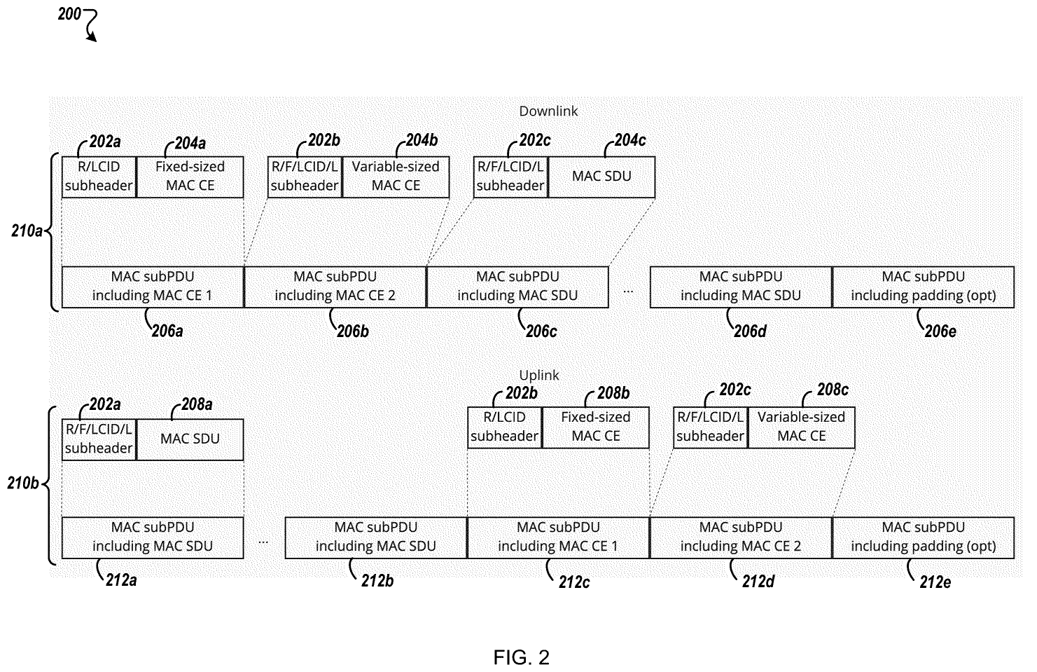

The UE 102 includes control circuitry 110 coupled with transmit circuitry 112 and receive circuitry 114. The transmit circuitry 112 and receive circuitry 114 may each be coupled with one or more antennas. The control circuitry 110 may be adapted to perform operations for receiving transport blocks such as those described herein with respect to FIGS. 2-9 and decoding the code blocks of the transport blocks based on an alignment of the MAC subheaders with the code block groups of the transport block. The control circuitry 110 may include various combinations of application-specific circuitry and baseband circuitry. The control circuitry 110 allows successfully decoded code block groups to be forwarded to higher layers of the UE for additional processing, even if awaiting HARQ retransmission from the transmitter. The transmit circuitry 112 and receive circuitry 114 may be adapted to transmit and receive data, respectively, and may include radio frequency (RF) circuitry or front-end module (FEM) circuitry, including communications using codecs as described herein.

In various embodiments, aspects of the transmit circuitry 112, receive circuitry 114, and control circuitry 110 may be integrated in various ways to implement the circuitry described herein. The control circuitry 110 may be adapted or configured to perform various operations such as those described elsewhere in this disclosure related to a UE. The transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108. Similarly, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In embodiments, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108.

The control circuitry 116 may be adapted to perform operations for configuring transport blocks to include MAC subheads that are aligned with code block groups within the transport block. The control circuitry 116 can configure the transport blocks described herein in relation to FIGS. 2-9. The transmit circuitry 118 and receive circuitry 120 may be adapted to transmit and receive data, respectively, to any UE connected to the base station 104 using data generated with various codecs described herein. The transmit circuitry 118 may transmit downlink physical channels includes of a plurality of downlink sub-frames. The receive circuitry 120 may receive a plurality of uplink physical channels from various UEs, including the UE 102.

In this example, the one or more channels 106A, 106B are illustrated as an air interface to enable communicative coupling, and can be consistent with cellular communications protocols, such as a GSM protocol, a CDMA network protocol, a PTT protocol, a POC protocol, a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any of the other communications protocols discussed herein. In embodiments, the UE 102 may directly exchange communication data via a ProSe interface. The ProSe interface may alternatively be referred to as a SL interface and may include one or more logical channels, including but not limited to a PSCCH, a PSSCH, a PSDCH, and a PSBCH.

FIG. 2 is a block diagram that illustrates contents of the transport block of MAC layer data configuration 200. The MAC layer data configuration 200 includes an uplink MAC subheader 210a or downlink MAC subheader 210b, depending on a transmission scenario. The uplink MAC subheader 210a includes LCID subheader fields 202a-c. Each LCID subheader field 202a-c is associated with a corresponding MAC CE 204a-c. The LCID field 202a-c identifies logical channel instances of a corresponding MAC SDU 208a-c, a type of corresponding MAC CE 204a-c, or padding present in the MAC sublayer (not shown). The MAC CE 204a-c is a MAC structure that carries control information for both downlink (DL) and uplink (UL) scenarios. Here, the MAC CEs for DL scenarios includes a fixed-size MAC CE 204a, a variable sized MAC CE 204b, and a MAC SDU 204c. The MAC CEs for UL scenarios include a MAC SDU 208a, a fixed-size MAC CE 208b, or a variable-sized MAC CE 208c. Each pair of the LCID subheaders 202a-c and the MAC CEs 204a-c or 208a-c is included in a MAC subPDU 206a-e (for DL scenarios) or a MAC subPDU 212a-e (for UL scenarios). The SDUs and PDUs carry data.

As previously described, a receiver is configured to decode the CBs of the CBGs. When a CBG is decoded, the data is forwarded to higher layers in the protocol stack. If a portion of a CBG is not decoded, the receiver requests a retransmission of the CBG. For example, in legacy systems, if a Hybrid Automatic Repeat Request (HARQ) process operates on a CBG level, and one of the CBGs is negatively acknowledged (NACKed), then the HARQ process does not forward the correctly decoded parts of another, correctly decoded CBG to the RLC. Instead, the HARQ process waits for HARQ retransmission, which is until the whole transport block (TB) is correctly decoded. Once this occurs, the decoded CBGs are forwarded to the higher layers.

In legacy systems, the receiver waits to decode the entire TB before forwarding any CBGs to the higher layers because the receiver has no data that maps a CB or CBG to a specific MAC PDU. The receiver, therefore, has no prior knowledge of where CB or CBG boundaries are in the transmission. In legacy systems, the TB includes the concatenated MAC CEs, MAC headers, and MAC SDUs. The TB is split into code blocks independently from consideration of the MAC PDU borders.

A size of each code block is defined in the 3GPP specification. CB length values are optimized for low density parity check (LDPC) decoding. The size of the code blocks depends on respective channel coding to be selected for 6^{th} generation (6G) networks. When a CB is NACKed in legacy systems, the receiver does not have data specifying packet boundaries that exist after that NACKed CB. Any potentially decoded CBs after the NACK'ed CB cannot be used by the receiver or forwarded to higher layers. The receiver (e.g., the UE) waits for HARQ retransmission to complete, and combines the soft bits to decode the previously NACKed CBs. Therefore, an ACKed CB that is positioned after the NACKed CB in the TB may not be forwarded to the higher layers, since its data content may be unknown. This may unnecessarily increase the latency for some MAC SDUs.

To overcome this issue, the systems and processes described herein are configured to align CBGs of the PHY layers and MAC SDUs or MAC CEs of the MAC layer. Alignment of fields of the MAC sublayer and the CBGs of the PHY layer enables the receiver to determine or predict where each CBG boundary is located within a transmission. When a receiver fails to decode a code block, the receiver can still determine where the boundary of the next CBG begins. The receiver (e.g., a UE) can use data from subsequent CBGs that are successfully decoded and that occur after a CB that is not successfully decoded. The receiver can forward the data from the decoded CBs to higher layers in the protocol stack in parallel with a Hybrid Automatic Repeat Request (HARQ) retransmission. The higher layers can begin using the data from decoded CBGs while the HARQ retransmission is still occurring.

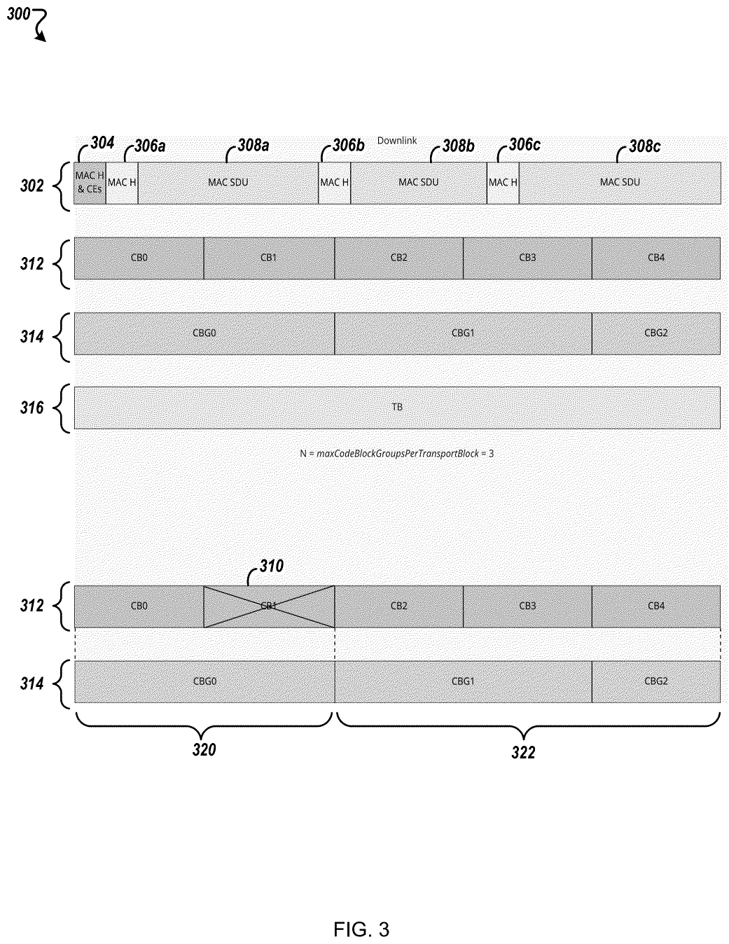

FIG. 3 is a block diagram that illustrates data of a RLC layer data configuration 300 for an MAC layer, including non-aligned MAC sub-headers and CBs. The MAC layer data configuration 300 includes a MAC CEs 302. The MAC CEs 302 are included in sequential code blocks (CBs) 312. The CBs are grouped into code block groups (CBGs) 314. The CBGs are each part of the transport block 316.

The transport block 316 is split into a number of CBGs M, where M=min(N, C) CBGs, and where N is a maximum number of CBGs per TB for radio resource control (RRC), designated as maxCodeBlockGroupsPerTransportBlock (RRC). In some implementations, if CBG transmission is disabled, then the number of CBGs is 1, and all CBs are a part of the same CBG. A value C represents a number of CBs in the TB, in accordance with 3GPP 38.212, § 7.2.3, and 3GPP 38.214, § 5.1.3.2. The number of CBs and their respective sizes each depends on parameters given in the downlink control information (DCI). For example, the DCI parameters can include modulation coding scheme (MCS), rank, time-frequency allocation of the PDSCH, and so forth. In an example, a first set M1 of CBGs each includes K1 CBs, while a last M-M1 CBGs include K2 CBs each, where M1=mod(C, M), K1=ceil(C/M), K2=floor(C/M). There is a uniform distribution of CBs in each CBG, as much as permitted.

As previously described, in a legacy TB 316, the boundaries of the MAC CEs 302 are not necessarily aligned with the CBs 312. For example, initial MAC header and CEs data 304 precedes a first MAC subheader 306a of a set of MAC subheaders 306a-c. MAC-CEs may comprise additional control information generated by a MAC layer of the protocol stack. MAC-CEs may be transported on the PDSCH/PUSCH. Examples of control information transferred as MAC-CEs may include timing advance commands, secondary cell activation or deactivation commands, reporting of Buffer Status and Power Headroom, or Transmission Configuration Indication (TCI) state indication or activation, etc.

The MAC subheaders 306a-c each precede a MAC SDU 308a-c for the downlink scenario shown in the MAC layer data configuration 300. In the example of MAC layer data configuration 300, the first CBG (CBG0) includes data 304, MAC subheader 306a, MAC SDU 308a, and part of MAC subheader 306b. The second CB (CB1) therefore includes part of MAC subheader 306b, and the MAC subheader 306b is not aligned with any of the CBs 312. Similarly, the CB3 includes part of MAC SDU 308b, MAC subheader 306c, and part of MAC SDU 308c.

In some implementations, the receiver does not successfully decode a CB, shown by a crossed-out CB 310. In this example, the receiver did not successfully decode CB1. The receiver therefore may request retransmission for CBG0. In this example, the receiver successfully decoded CBGs 1 and CBG2, including CB2, CB3, and CB4. Even though an ACK is returned for the receiver for these CBs, the receiver cannot forward these data to higher layers because the receiver does not know what MAC subheaders or MAC SDUs correspond to the received data. For example, the receiver cannot designate data as being a MAC subheader, a MAC SDU, or a MAC CE when forwarding the data to the higher layer for further processing.

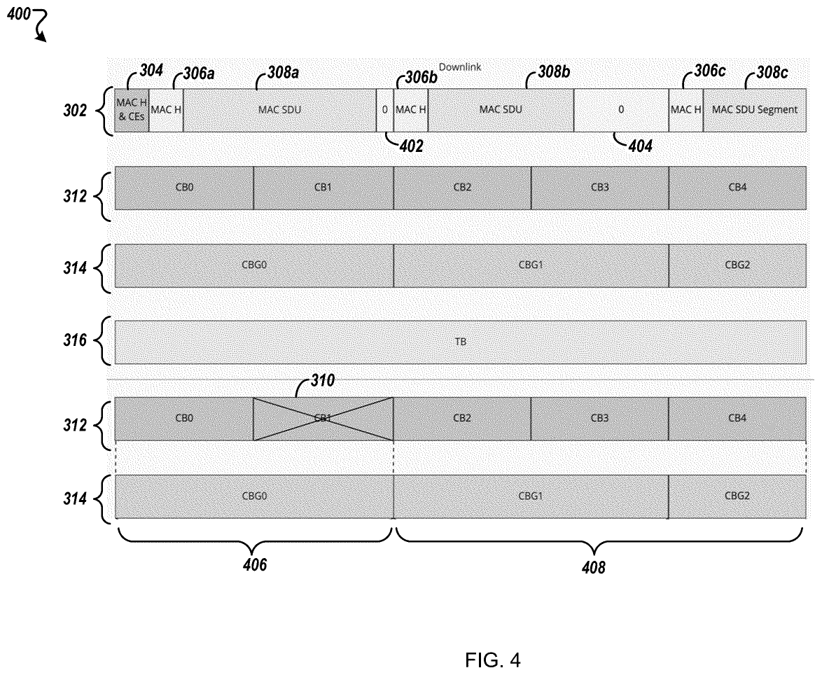

FIG. 4 is a block diagram that illustrates a MAC layer data configuration 400 including CBGs aligned with MAC sub-headers. As described in relation to FIG. 3, the MAC layer data configuration 400 includes MAC CEs 302, which are included in CBs 312 that are grouped into CBGs 314 in the TB 316. For the MAC layer data configuration 400, the MAC subheaders 306a-c are aligned in the transmission with CBG boundaries (and therefore with CB boundaries). The alignment can be achieved by the transmitter by including padding symbols 402, 404 between MAC CEs.

In the MAC layer data configuration 400, multiple MAC PDUs of a same or different logical channels may be multiplexed in the same TB 316. In some implementations, correctly decoded CBGs 314, which correspond to a logical channel (e.g., channel X), are forwarded to the upper layers without waiting for the retransmission of the other CBGs. The other CBGs may correspond to the same logical channel (logical channel X) or to other logical channels (e.g., logical channel Y or Z).

The transmitter enforces a requirement that a beginning boundary of each CBG is aligned with a quantity (e.g., a field such as the MAC subheader) that is known to both the transmitter and the receiver prior to decoding. The configuration of the MAC boundaries can be transmitted in configuration data prior to transmission of the MAC CEs. For example, for a given TB 316, a beginning boundary of each CBG could be required to be aligned with a beginning boundary of a MAC subHeader. In an example, a first CBG CBG0 is aligned with the first MAC subHeader 304. This could be applied to 5G TBs, given the structure, or to 6G TBs, wherein a similar procedure would be applied in 6G even with a different but well-defined TB structure.

Each CBG includes as many CBs as needed for including a whole MAC subPDU. For example, the CBG0 includes two CBs, CB0 and CB1. The end boundary of CB1 (and therefore CBG0) aligns with the MAC subheader 306b. Similarly, the end boundary of CB1, which includes CB2 and CB3, aligns with the MAC subheader 306c. In some implementations, the DCI indicates how many CBs exist in each CBG for a transmission. If the CBG size (in bits), after counting all included CBs, is higher than the MAC subPDU size, the padding 402 or 404 is included. The padding fills the CBG, such as to the end of the last CB of that CBG and forces the next MAC subheader to be aligned with the next CBG.

HARQ feedback is performed on a CBG level as previously described. For example, if a CB is improperly decoded at the receiver, HARQ feedback is NACK for that CB. The receiver requests retransmission of the affected CBG including the NACKed CB. However, subsequent CBGs are unaffected, and the receiver may forward the subsequent ACKed CBGs to higher layers prior to receiving the HARQ retransmission of the NACKed CBGs. The receiver can forward the data of the subsequent CBGs because the receiver can determine what the data represents, such as when a new MAC subheader begins (e.g., at a CBG boundary).

A receiver can determine a length of a MAC subPDU based on processing a decoded (ACKed) CB. If the MAC subPDU ends at another ACKed CB, the receiver can read the next MAC subheader in that CB, even if the intermediate CBs were unsuccessfully decoded (NACKed). The receiver does not have to determine whether it can read the next MAC subheader or not. This is because the receiver can automatically assume that the subheader corresponds to a beginning of a subsequent CBG.

As previously discussed, the receiver is configured to reduce processing delay (latency) and avoid processing peaks in higher layers. The receiver is configured to forward each decoded (ACKed) CBG directly to the RLC layer, because each CBG includes a complete MAC subPDU 308. The RLC layer can, in turn, perform RLC segments reassembly (if needed). An RLC SDU 308a-c can be reassembled without a complete reception of the TB 316 and the RLC SDU 308a-c can be forwarded to PDCP. If there is no reordering at the PDCP level, once deciphering occurs, the deciphered RLC SDU data are passed to the SDAP layer. The SDAP layer performs QoS mapping and forwards the mapping to higher layers. This process initiates without waiting for the whole TB 316 to be successfully decoded (ACKed). The upper layers can begin processing at least portions of the TB 316 (the decoded CBGs), avoiding processing peaks. The reduction in latency can compensate for any throughput reduction due to the addition of padding bits 402, 404.

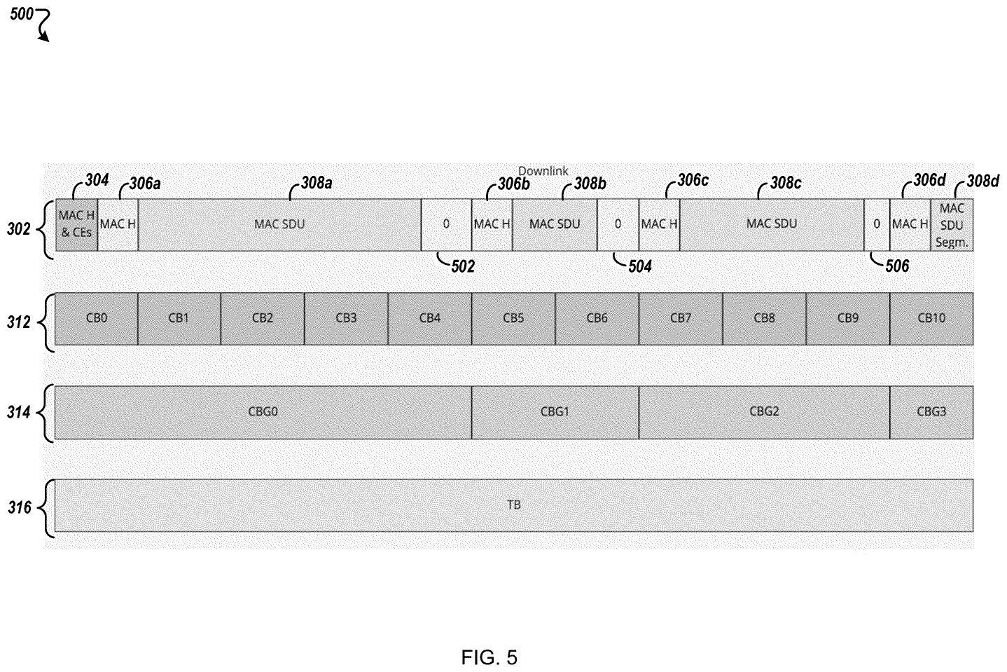

FIG. 5 is a block diagram that illustrates a MAC layer data configuration 500 including CBGs having variable numbers of CBs and being aligned with MAC sub-headers. As previously described, each CBG 314 includes at least one complete MAC SDU 308a-c. Each CBG is configured to include as many CBs as needed to include an entire MAC subPDU in the CBG. The DCI is configured to indicate the number of CBGs 314 and, for each CBG, the number of CBs that are included in that CBG.

In MAC layer data configuration 500, there are four CBGs, each including a different number of CBs. For example, the CBG0 includes five CBs (CB0, CB1, CB2, CB3, and CB4). CBG1 includes two CBS (CBS, CB6). CBG2 includes three CBGs (CB7, CB8, CB9). CBG3 includes one CB (CB10). In this example, each CBG includes a unique number of CBs, but this is not necessary. For example, two CBGs may each include two CBS, three CBs, 1 CB, or any number of CBs needed to include the entire MAC subPDU or SDU. As seen in FIG. 5, padding 502 is added after MAC SDU 308a to fill CB4, and align the border of the next MAC CE with CBG1. Padding 504 is added after MAC SDU 308b to fill CB6 and align the border of the next MAC CE with CBG2. Padding 506 is added after MAC SDU 308c to fill CB9 and align the border of the next MAC CE with CBG3. This achieves the border alignment of the CBGs, and the MAC CEs as previously described, enabling successfully decoded CBGs to be sent to higher layers even when other CBGs are unsuccessfully decoded (NACKed).

In some implementations, a CB-to-CBG mapping is dynamically selectable by the transmitter. This mapping can be sent to the receiver in the DCI. In some implementations, a padding size 502, 504, or 508 could be reduced due to the dynamic CB-to-CBG mapping, which can increase throughput efficiency.

To perform dynamic CB-to-CBG mapping, the receiver may perform one of a number of processes. In a first method, a CB-CRC mask, which refers to a CB cyclic redundancy check (CRC) mask. Each CB-CRC mask corresponds to a different pair of data values. The data values indicate a CBG identifier and a corresponding number of CBs in the CBG. The mapping process includes performing an “XOR” operation to the CRC of each CB using the specific CB-CRC mask that corresponds to the CBG identifier and to the number of CBs in the CBG of that CB. The receiver tries each of the CB-CRC masks in order to find the correct mask until a mask is found that causes CRC to pass.

A number of CB-CRC masks are generated and applied. A maximum MAC subPDU size is 9014 bytes. The maximum MAC subPDU size corresponds to max 9 CBs or max 19 CBs (e.g., for NR networks), depending on whether a coding rate is higher or lower than ¼, respectively. If a maximum number of CBGs equal to 8 (as in NR), this means that 72 (e.g., 9×8) and 152 (e.g., 19×8) CB-CRC masks would have to be determined when provisioning for the max number of CBs per MAC SDU. As an example, a typical MAC SubPDU size is −1500 bytes. Because a CBG includes an entire MAC SDU, a CBG would include about 2 to 4 CBs in most practical instances. For this size of CBG, there are 4 (CBs per CBG)×8 (CBGs)=32 CB-CRC masks. These 32 masks are more frequently used. The receiver is configured to check these 32 masks, first.

A second CBG-CB mapping process is now described. A device (e.g., the receiver) generates a bitmap of log 2(C) bits, where C is the number of CBs 314 in the TB 316. Because the value of C is calculated at the receiver and it is not indicated through the DCI, this field can only be read after C has been obtained. This means that all DCI parameters that are used in the calculation of C should be put before this bitmap in the DCI. Each bit in the bitmap corresponds to a respective CB. Starting from bit value 0 and the first bit of the bitmap, the CBs of all subsequent bits that are equal to 0 belong to CBG #0. Then, the CBs of all subsequent bits that are equal to 1 belong to CBG #1. Then, the CBs of all subsequent bits that are equal to 0 belong to CBG #2, and so on. For example, a number of CBGs is equal to a number of bit flips+1. An example bitmap is 00000110001. CBG0 includes CB0-4; CBG1 includes CB5-6; CBG2 includes CB7-9; CBG3 includes CB10. This vector therefore represents the number of CBGs number and respective CBG sizes in the TB 316.

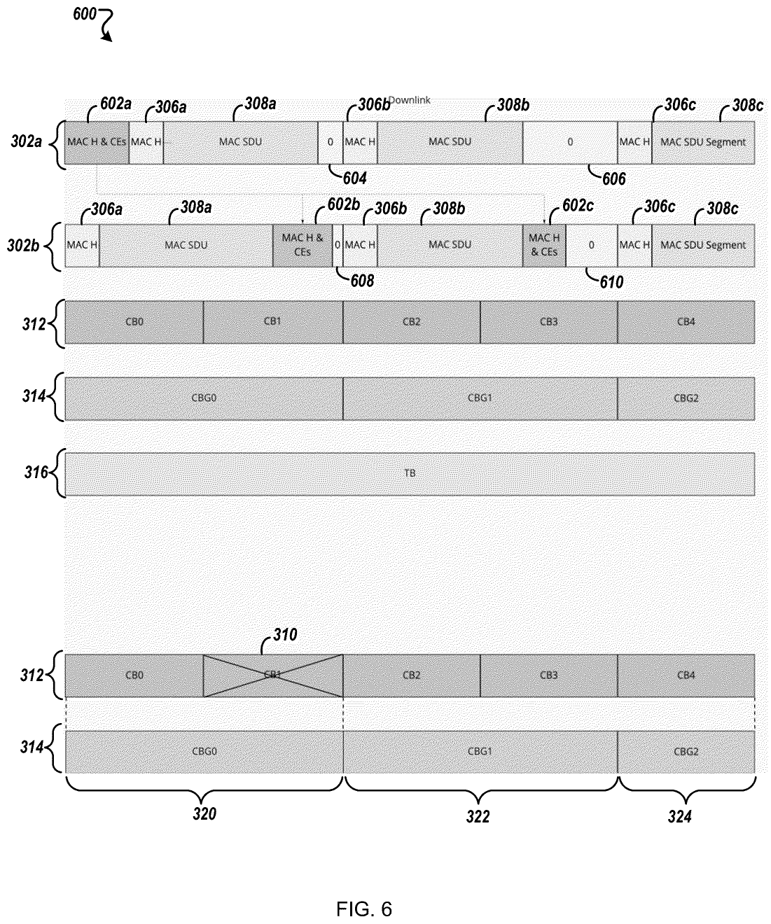

FIG. 6 is a block diagram that illustrates a MAC layer data configuration 600 including CBGs being aligned with MAC sub-headers and interspersed MAC CEs. Here, MAC subheaders 302a are shown before MAC CEs 304a are split. MAC subheaders 302b are shown after the MAC CEs 304b, 304c are split. As previously described, the transmitter enforces a requirement that a beginning of each CBG is aligned with the beginning of a MAC subPDU. In this example, MAC CEs 602a are split to be interspersed as MAC CEs 602b and 602c between the MAC SDUs 308a-c. This split can be configured to reduce the MAC padding size for padding 604 or for padding 606, which are each trailing a previous MAC subPDU to enforce the boundary alignment. In some implementations, the MAC CEs 602b, 602c are placed in between MAC subPDUs. Reconfiguring the MAC headers from 302a to 302b reduces the size of padding 604 to be padding 608, and the size of padding 606 to be padding 610. This increases a throughput efficiency for enforcing boundary alignment of the CBGs with the MAC SDUs. For NR networks, for DL scenarios, the MAC CEs are at the beginning of the TB 316. For NR networks, for UL scenarios, the MAC CEs are at the end of the TB 316 (e.g., before optional padding). FIG. 6 shows a DL scenario.

The MAC CEs 602 that do not fit at the end of a CBG (e.g., for 302b to reduce the number of padded zeros) can remain at the beginning of the TB 316 (for DL) or end of the TB (for UL). In this case, the receiver performs additional processing to determine where to place the MAC CEs 602. If a MAC subheader and MAC SDU size together are larger than a fixed CBG size, and this size spans over two CBGs, the MAC entity buffers the 2 CBGs first. Buffering is performed before forwarding the complete MAC SDU to RLC.

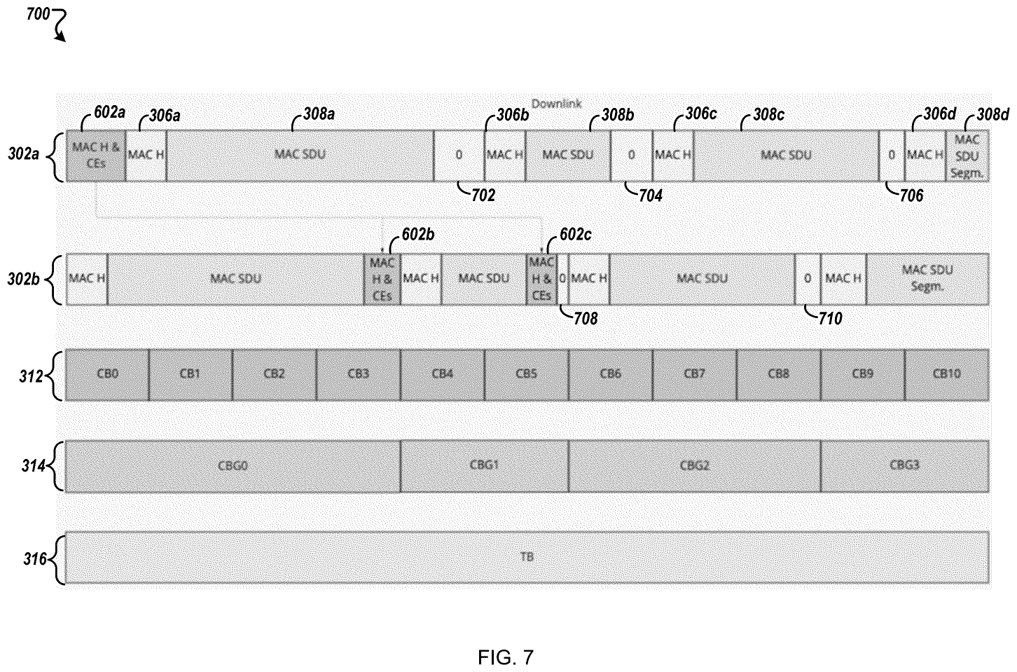

FIG. 7 is a block diagram that illustrates a MAC layer data configuration 700 including CBGs having variable numbers of CBs, being aligned with MAC sub-headers, and having interspersed MAC CEs. MAC layer data configuration 700 configuration is a combination of the MAC layer data 500 and 600, previously described. As shown in FIG. 7, padding 702 is eliminated entirely from configuration 302a to configuration 302b. Padding 704 is reduced in size to padding 708. Padding 706 is reduced in size to padding 710. Four CBGs are transmitted, each including a corresponding MAC subheader 306 and MAC SDU 308, and each having an aligned boundary with the corresponding MAC SDU.

The MAC layer data 700 enables increased throughput and resource efficiency because there is a more accurate fitting of CBGs to MAC PDU borders, and less padding is needed (compared to border alignment without MAC CE splitting). The transmitter determines the optimal combination prior to transmitting. If the optimum configuration is difficult to determine (e.g., packet sizes are very heterogeneous), the transmitter can fall back to a default CBG scheme.

By introducing different modes for CBG, the transmitter indicates whether the receiver should assume that the beginning borders of the CBGs are aligned with the respective beginning of a MAC CE, a MAC header, or whether there is no alignment. These configurations depend on the mode of operation. For mode 1 CBG operation (as currently done in NR), the receiver does not assume anything about the mapping between CBG and MAC subheaders. For mode 2, CBG operation is performed as previously discussed in relation to FIG. 4, 5, or 6, where receiver assumes that the beginning of each CBG is aligned with a MAC subheader.

The CBG mode can be signaled using the DCI. In some implementations, different radio bearers with different QoS are configured and used. Each radio bearer may be associated with a different CBG mode. The transmitter determines the CBG mode based on the radio bearers that are mapped to the TB at each certain point in time.

CBG Mode 2 is beneficial in various circumstances. For example, a radio bearer that is not configured with in-sequence delivery benefits from CBG Mode 2. This is because, in that case, a correctly decoded CBG may include an MAC SDU which would be forwarded to the higher layers without waiting for the correct reception of the previous CBGs. The result is a reduced latency and less memory consumption (relative to CBG mode 1), because no buffering is performed. In another example, a radio bearer with traffic that fits to CB borders (e.g., streaming with certain packet size) could result in reduced latency and reduced padding. In another example, end-to-end application layer alignment is performed on packet sizes to fit the CB/CBG sizes, especially if they are fixed size. This configuration results in a reduced latency and reduced padding.

In some implementations, a CBG mode for the entire TB is referenced in the DCI. For example, a single bit could be included in the DCI. The bit represents the CBG mode for all CBGs in the TB. In this example, a same mode is applied to all LCs belonging to the same TB. DCI examples are now described. In NR networks, CBG Transmission Information (CBGTI) includes a bitmap of 2, 4, 6 or 8 bits, based on the number of CBGs, indicating which CBGs are transmitted. Additionally, in NR networks, CBG Flushing out Information (CBGFI) includes 1 bit indicating whether the retransmitted CBGs should be combined with the earlier received instances of the same CBGs or not. To this information, CBG Mode Information (CBGMI) is added, including 1 bit indicating the CBG mode of all CBGs.

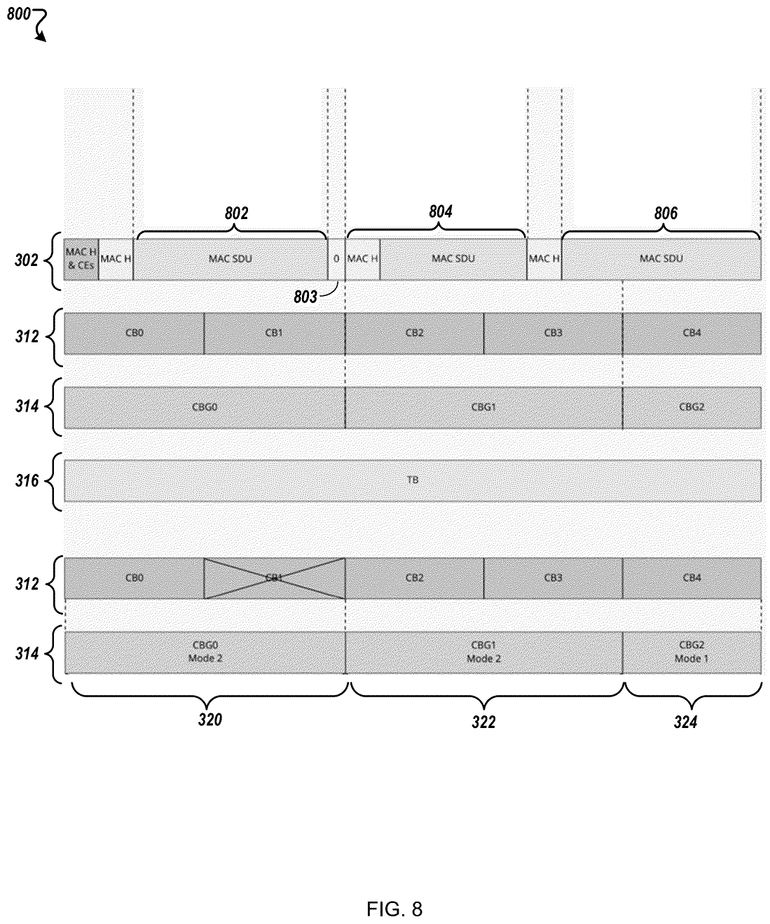

FIG. 8 is a block diagram that illustrates a MAC layer data configuration 800 including CBGs being aligned with MAC sub-headers and a CBG mode bitmap. MAC SDU 802 corresponds to CBG0, which is in mode 2. For MAC SDU 802, RBx with in-order delivery is automatically associated with CBG mode 2 because this is the first CBG in the set of CBGs for RLC layer data configuration 800. The CBG0, if decoded, can be forwarded for processing by SDAP, PDCP, and RLC layers. In this example, because CB1 was unsuccessfully decoded (NACKed), CBG0 is subject to HARQ retransmission before forwarding occurs.

MAC SDU 804 corresponds to CBG1, which is in mode 2. For MAC SDU 804, RBy with out-of-order delivery is associated with CBG mode 2. The CBG1, if decoded, can be forwarded for processing by RLC, PDC and SDAP layers. In this example, because CB2 and CB3 are successfully decoded (ACKed), CBG1 data can be forwarded to higher layers.

MAC SDU 806 corresponds to CBG2, which is in mode 1. For MAC SDU 804, RBz with in-order delivery is associated with CBG mode 1. For CBG2 to be forwarded for processing by SDAP, PDCP, and RLC layers, all CBGs prior to the CBG2 up to and including a CBG with CBG mode 2 should have been successfully decoded. In this example, because CBG1 is successfully decoded (ACKed) and has mode 2 (is aligned with a MAC SDU boundary at CB2), CBG2 data can be forwarded to higher layers if successfully decoded because the receiver can be sure that the MAC subheader and MAC SDU are received.

With this approach, the transmitter is able to select, mix and match the RLC PDUs of different logical channels and pad zeros at the end of a CBG whenever the transmitter determines that it is beneficial for the subsequent CBG to be aligned with the beginning of an RLC PDU. This configuration can be done per MAC subPDU or even per LC, based on the RB/LC configuration (e.g., out-of-order delivery). The CBG mode bitmap has a length equal to the number of CBGs. In some implementations, the MAC forwards a complete MAC SDU/RLC PDU to the RLC layer. Each bit of the CBG mode bitmap indicates whether the beginning of the associated CBG is aligned with the beginning of a MAC header or not.

In the example of FIG. 8, the transmitter has opted to associate RBy with CBG Mode 2, therefore it has set CBG2, which is the only CBG that carries the data of RBy, to have CBG Mode 2. The transmitter has zero-padded the last bits 803 of CBG0 so that the start of CBG1 is aligned with the start of a MAC header for MAC SDU 804. When the data of RBy has been mapped to the TB 316, the data of RBz are set afterwards without zero-padding, because RBz is associated with CBG mode 1. The receiver determines which CBG is associated with which mode via DCI. The receiver may derive which correctly decoded bits can be forwarded to the higher layers and which bits cannot be forwarded. The transmitter may determine to select the best order that the RLC PDUs are mapped in the TB 316 based on which sequence minimizes a number of zero-padded bits 803. The transmitter can make this determination because the transmitter has information describing the length of each CBG. The RLC PDUs that should be mapped to the TB 316 based on their prioritization are still be mapped to that TB 316. Rather, only the internal order of the PDUs (e.g., CBG mapping) is adjusted by the transmitter.

Because of this configuration, the transmitter does not have to decode the first CB of each CBG to determine whether the content of the CBG can be forwarded to the higher layers. This information is available to the receiver prior to decoding. If a CB included in a CBG fails the decoding, then the receiver can skip the decoding of the rest of the CBs until the first CB of the next CBG that has CBG Mode Indicator (CBGMI) equal to 2. The size of the DCI is increased, and padded bits are not repurposed.

The DCI is adjusted as follows. The CBG Transmission Information (CBGTI) is present in NR DCI and includes a bitmap of 2, 4, 6 or 8 bits, based on the number of CBGs, indicating which CBGs are transmitted. The CBG Flushing out Information (CBGFI) is included in NR and includes 1 bit indicating whether the retransmitted CBGs should be combined with the earlier received instances of the same CBGs or not. The CBG Mode Information (CBGMI) is added. The CBGMI includes a bitmap of 1, 3, 5 or 7 bits, based on the number of CBGs minus 1, indicating the CBG mode of each CBG. The first CBG (CBG0) is not part of the bitmap, since the first CBG is always associated with CBG Mode 2 (e.g., CBGMI=1). The first bit of the CBGMI bitmap corresponds to CBG1, the second bit to CBG2 and so forth. If the nth bit is equal to {0, 1}, then the (n+1)th CBG is associated with CBG mode {1, 2}.

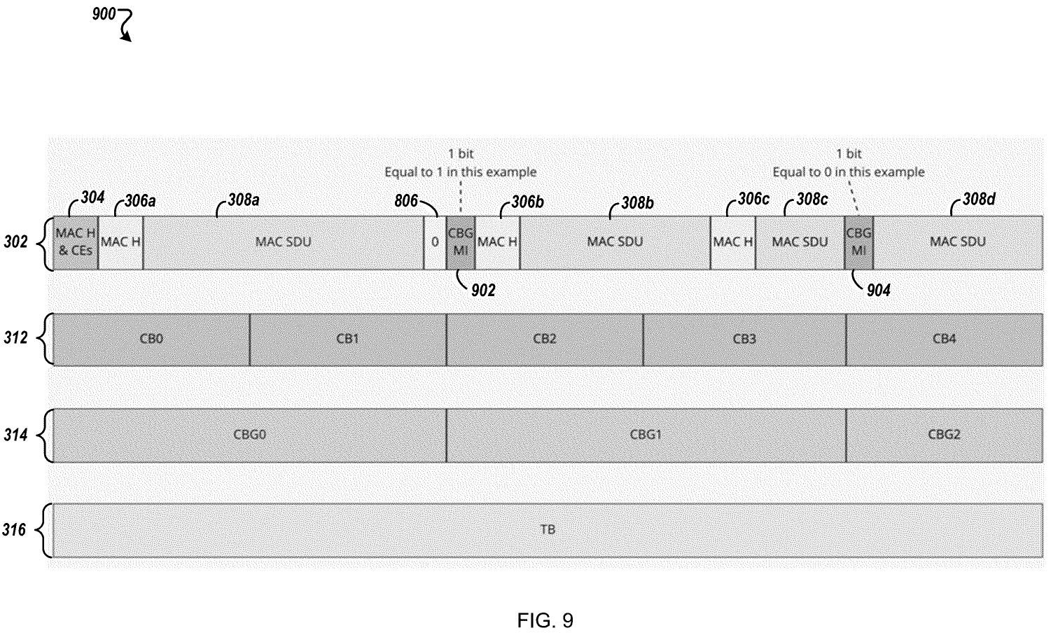

FIG. 9 is a block diagram that illustrates a MAC layer data configuration 900 including CBGs being aligned with MAC sub-headers and a CBG mode per CBG bit 902, 904 in the MAC sub-header. In some implementations, instead of sending the CBG mode of each CBG in the DCI (as previously described), a mode indicator bit 902, 904 is included at the beginning of each CBGs payload. The receiver determines whether a given CBG is aligned with the start of a MAC subheader after correctly decoding the CBG, such as by reading the first bit 902, 904, etc. Such operation is sufficient for decoding by the receiver because the receiver does not use the information of CBG mode indicator (MI) 902, 904 prior to successful decoding of the CBG. The MAC configuration includes this extra bit 902, 904 per CBG when informing the upper layers of the available grant size and allocates one bit less per CBG.

The configuration of the mode indicator bit is possible if there are no CBGs, and instead only CBs are available. The MI bit 902, 904 is applied at the CB level 312 instead of CBG level 314. A CB mode is included for the transmitter, the mode having a same operation as the CBG mode. The mapping by the transmitter is therefore even more dynamic than if only CBG-based mapping is available, though more bits are included in order to indicate the mode of each CB (e.g., 1 bit per CB instead of per CBG).

The mode indication enables the benefits of latency reduction and processing peak avoidance (for higher layers) as described previously. The throughput accommodates the addition of padding bits and extra header bits, which may reduce throughput. The DCI size is not increased, and less padding is needed. The receiver decodes the CB first in order to see whether the content of the CBG can be forwarded to the higher layers.

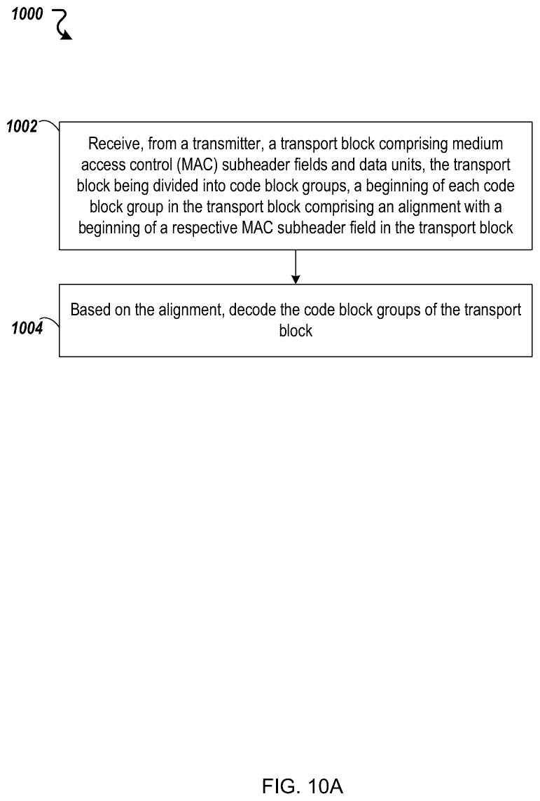

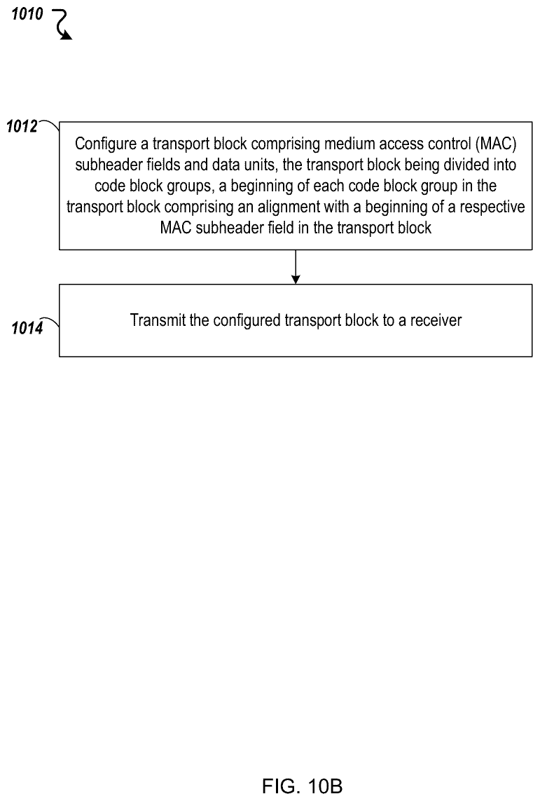

FIG. 10A illustrates a process 1000 for communicating in a wireless network using CBGs aligned with MAC sub-headers. The process 1000 includes receiving (1002), from a transmitter (e.g., a base station), a transport block comprising medium access control (MAC) subheader fields and data units. The transport block is divided into code block groups. A beginning of each code block group in the transport block includes an alignment with a beginning of a respective MAC subheader field in the transport block. The process 1000 includes, based on the alignment, decoding (1004) the code block groups of the transport block.

In some implementations, the process 1000 includes determining that a code block group, of the code block groups, is successfully decoded. The process 1000 includes sending the decoded code block group to a higher layer, the sending being independent of decoding the transport block in entirety.

In some implementations, the process 1000 includes, while sending the decoded block group to the higher layer, performing Hybrid Automatic Repeat Request (HARD) retransmission for another code block group that is not successfully decoded.

In some implementations, the transport block includes padding between a data unit and a subsequent MAC subheader, the padding enabling the alignment between the beginning of a code block group in the transport block and the beginning of the respective MAC subheader field in the transport block.

In some implementations, the code block groups each comprise one or more code blocks, a code block representing a data packet that is encoded or decoded for transmitting data in the transport block. In some implementations, the code block groups each comprise a same number of code blocks. In some implementations, a first code block group of the code block groups comprises a first number of code blocks, wherein a second code block group comprises a second number of code blocks, and wherein the first number is different from the second number. In some implementations, the first number is configured to reduce a padding required to align the beginning of each code block group in the transport block being with the beginning of the respective MAC subheader field. In some implementations, the first number is configured to enable the first code block group to include a first data unit that a larger than a second data unit of the second code block group.

In some implementations, a mapping of code blocks to respective code block groups is configured by the transmitter depending on a number of the data units of the transport block, a size of the data units of the transport block, or both the number and the size of the data units.

The process 1000 can include receiving downlink control information (DCI) that specifies a configuration of the transport block, the configuration indicating the alignment of the beginning of each code block group in the transport block with the beginning of a respective MAC subheader field in the transport block.

The process 1000 can include receiving downlink control information (DCI) specifying mask data, the mask data indicating a number of code blocks for each code block group and an order for the code block groups.

The process 1000 can include, decoding, for a code block group, a mode indicator bit, the mode indicator bit indicating whether the code block group is aligned with a corresponding MAC subheader.

The process 1000 can include receiving mode indicator data in downlink control information (DCI), the mode indicator data indicating, for one or more code blocks of the transport block, whether a given code block group is aligned with a corresponding MAC subheader. In some implementations, MAC control elements (CEs) are interspersed in the transport block among the MAC subheaders and the data units.

In some implementations, a first code block group of the code block groups comprises a first number of code blocks, wherein a second code block group comprises a second number of code blocks, and wherein the first number is different from the second number. The MAC control elements (CEs) are interspersed in the transport block among the MAC subheaders and the data units. The first number and the second number are configured based on respective lengths of the data units, and wherein the MAC CEs are interspersed based on padding space available in one or more of the first code block group or the second code block group, the padding space enabling the alignment of the beginning of each code block group in the transport block with the beginning of a respective MAC subheader field in the transport block.

In some implementations, the process 1000 includes receiving downlink control information (DCI) specifying mask data, the mask data indicating a number of code blocks for each code block group and an order for the code block groups.

The transport block includes the MAC PDU. A MAC PDU is split into MAC subPDUs. A MAC subPDU may contain one of the following: (1) a MAC subHeader and a fixed-size MAC CE, (2) a MAC subHeader and a variable-size MAC CE, (3) a MAC subHeader and a MAC SDU, and (4) padding. In some implementations, the transport block is configured for an uplink communication scenario. In some implementations, the transport block is configured for a downlink communication scenario. In some implementations, the transmitter is part of a base station, and the receiver is part of a user equipment. In some implementations, the transmitter is part of a user equipment, and the receiver is part of a base station.

FIG. 10B illustrates a process 1010 for communicating in a wireless network using CBGs aligned with MAC sub-headers. The process 1010 includes configuring (1012) a transport block comprising medium access control (MAC) subheader fields and data units. The transport block is divided into code block groups. A beginning of each code block group in the transport block includes an alignment with a beginning of a respective MAC subheader field in the transport block. The process 1000 includes transmitting (1014) the configured transport block to a receiver.

In some implementations, the process 1010 includes adding a padding between a data unit and a subsequent MAC subheader, the padding enabling the alignment between the beginning of a code block group in the transport block and the beginning of the respective MAC subheader field in the transport block.

In some implementations, the code block groups each comprise one or more code blocks, a code block representing a data packet that is encoded or decoded for transmitting data in the transport block. In some implementations, the code block groups each comprise a same number of code blocks. In some implementations, a first code block group of the code block groups comprises a first number of code blocks, wherein a second code block group comprises a second number of code blocks, and wherein the first number is different from the second number.

The process 1010 can include adjusting a number of code blocks for a particular code block group based on a size of a particular data unit include in the code block group.

The process 1010 can include sending downlink control information (DCI) to the receiver, the DCI specifying a mapping between the code block groups and the data units. The process 1010 can include mapping wherein a mapping of code blocks to respective code block groups is performed dynamically by the transmitter.

The process 1010 can include sending downlink control information (DCI) that specifies a configuration of the transport block, the configuration indicating the alignment of the beginning of each code block group in the transport block with the beginning of a respective MAC subheader field in the transport block.

In some implementations, MAC control elements (CEs) are interspersed in the transport block among the MAC subheaders and the data units.

In some implementations, the process 1010 includes sending downlink control information (DCI) specifying mask data, the mask data indicating a number of code blocks for each code block group and an order for the code block groups.

In some implementations, the process 1010 includes adding a mode indicator bit to a code block group, the mode indicator bit indicating whether the code block group is aligned with a corresponding MAC subheader.

In some implementations, the process 1010 includes sending a mode indicator data to the receiver in downlink control information (DCI), the mode indicator data indicating, for one or more code blocks, whether a given code block group is aligned with a corresponding MAC subheader.

The transport block includes the MAC PDU. A MAC PDU is split into MAC subPDUs. A MAC subPDU may contain one of the following: (1) a MAC subHeader and a fixed-size MAC CE, (2) a MAC subHeader and a variable-size MAC CE, (3) a MAC subHeader and a MAC SDU, and (4) padding. In some implementations, the transport block is configured for an uplink communication scenario. In some implementations, the transport block is configured for a downlink communication scenario. In some implementations, the transmitter is part of a base station, and the receiver is part of a user equipment. In some implementations, the transmitter is part of a user equipment, and the receiver is part of a base station.

The example processes 1000 and 1010, shown in FIGS. 10A-10B, can be modified or reconfigured to include additional, fewer, or different steps (not shown in FIGS. 10A-10B), which can be performed in the order shown or in a different order.

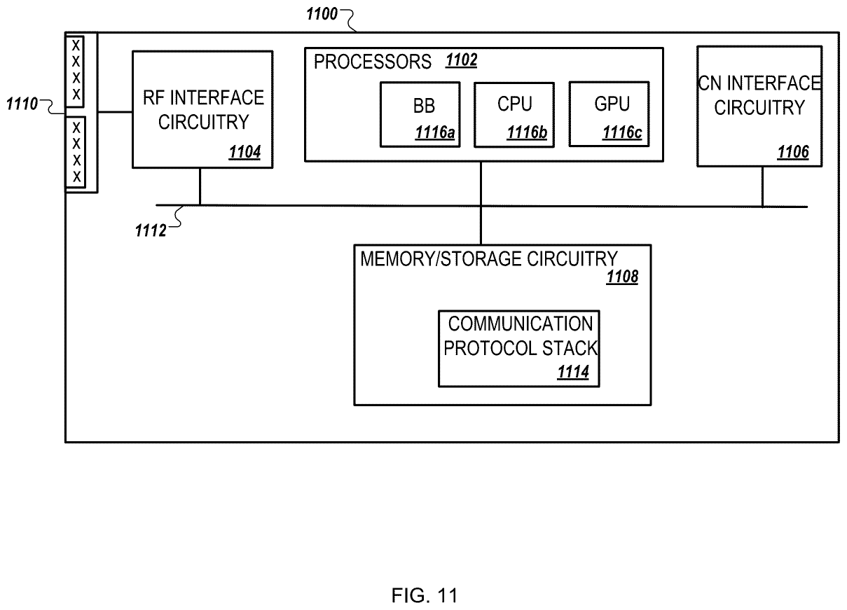

FIG. 11 illustrates an access node 1100 (e.g., a base station or gNB), in accordance with some embodiments. The access node 1100 may be similar to and interchangeable with base station 104. The access node 1100 may include processors 1102, RF interface circuitry 1104, core network (CN) interface circuitry 1106, memory/storage circuitry 1108, and antenna structure 1110. The access node 1110 can configure PHY and MAC layer data according to the configurations described in relation to FIGS. 2-10B. In some implementations, the access node 1100 transmits data to the UE describing the configuration in advance of sending MAC CEs according to the configuration, as described herein.

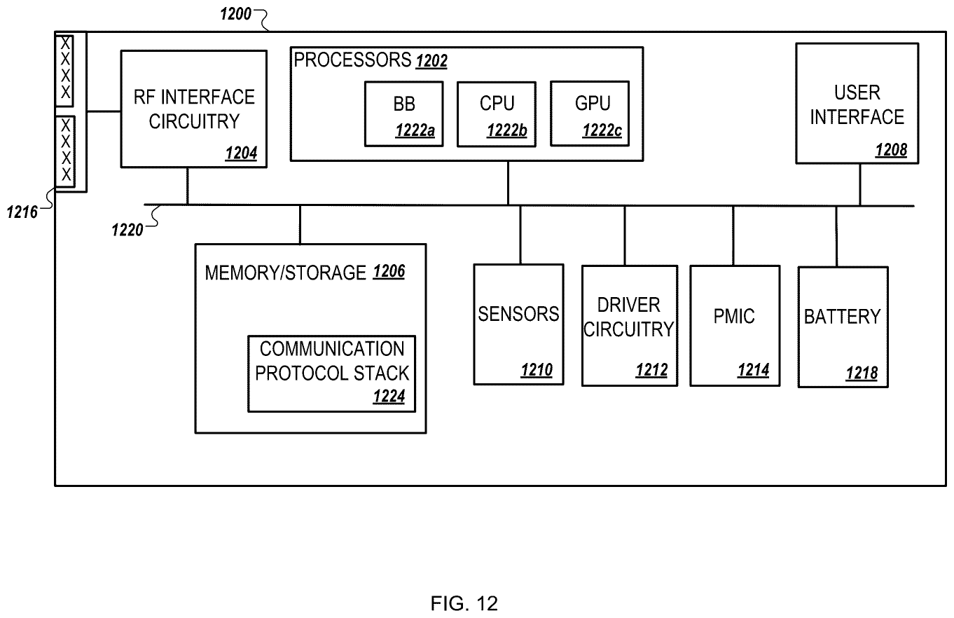

The components of the access node 1100 may be coupled with various other components over one or more interconnects 1112. The processors 1102, RF interface circuitry 1104, memory/storage circuitry 1108 (including communication protocol stack 1114), antenna structure 1110, and interconnects 1112 may be similar to like-named elements shown and described with respect to FIG. 12. For example, the processors 1102 may include processor circuitry such as, for example, baseband processor circuitry (BB) 1116A, central processor unit circuitry (CPU) 1116B, and graphics processor unit circuitry (GPU) 1116C.

The CN interface circuitry 1106 may provide connectivity to a core network, for example, a 5th Generation Core network (5GC) using a 5GC-compatible network interface protocol such as carrier Ethernet protocols, or some other suitable protocol. Network connectivity may be provided to/from the access node 1100 via a fiber optic or wireless backhaul. The CN interface circuitry 1106 may include one or more dedicated processors or FPGAs to communicate using one or more of the aforementioned protocols. In some implementations, the CN interface circuitry 1106 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1100 that operates in an NR or 5G system (for example, a gNB), and the term “E-UTRAN node” or the like may refer to an access node 1100 that operates in an LTE or 4G system (e.g., an eNB). According to various embodiments, the access node 1100 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some embodiments, all or parts of the access node 1100 may be implemented as one or more software entities running on server computers as part of a virtual network, which may be referred to as a CRAN and/or a virtual baseband unit pool (vBBUP). In these embodiments, the CRAN or vBBUP may implement a RAN function split, such as a PDCP split wherein RRC and PDCP layers are operated by the CRAN/vBBUP and other L2 protocol entities are operated by the access node 1100; a MAC/PHY split wherein RRC, PDCP, RLC, and MAC layers are operated by the CRAN/vBBUP and the PHY layer is operated by the access node 1100; or a “lower PHY” split wherein RRC, PDCP, RLC, MAC layers and upper portions of the PHY layer are operated by the CRAN/vBBUP and lower portions of the PHY layer are operated by the access node 1100.

FIG. 12 illustrates a UE 1200, in accordance with some embodiments. The UE 1200 may be like and interchangeable with UE 102 of FIG. 1. The UE 1200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smart watch), relaxed-IoT devices.

The UE 1200 may include processors 1202, RF interface circuitry 1204, memory/storage 1206, user interface 1208, sensors 1210, driver circuitry 1212, power management integrated circuit (PMIC) 1214, antenna structure 1216, and battery 1218. The components of the UE 1200 may be implemented as integrated circuits (ICs), portions thereof, discrete electronic devices, or other modules, logic, hardware, software, firmware, or a combination thereof. The block diagram of FIG. 12 is intended to show a high-level view of some of the components of the UE 1200. However, some of the components shown may be omitted, additional components may be present, and different arrangement of the components shown may occur in other implementations.

The components of the UE 1200 may be coupled with various other components over one or more interconnects 1220, which may represent any type of interface, input/output, bus (local, system, or expansion), transmission line, trace, optical connection, etc., that allows various circuit components (on common or different chips or chipsets) to interact with one another.

The processors 1202 may include processor circuitry such as, for example, baseband processor circuitry (BB) 1222A, central processor unit circuitry (CPU) 1222B, and graphics processor unit circuitry (GPU) 1222C. The processors 1202 may include any type of circuitry or processor circuitry that executes or otherwise operates computer-executable instructions, such as program code, software modules, or functional processes from memory/storage 1206 to cause the UE 1200 to perform operations as described herein.

In some embodiments, the baseband processor circuitry 1222A may access a communication protocol stack 1224 in the memory/storage 1206 to communicate over a 3GPP compatible network. In general, the baseband processor circuitry 1222A may access the communication protocol stack to perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some embodiments, the PHY layer operations may additionally/alternatively be performed by the components of the RF interface circuitry 1204. The baseband processor circuitry 1222A may generate or process baseband signals or waveforms that carry information in 3GPP-compatible networks. In some embodiments, the waveforms for NR may be based cyclic prefix OFDM “CP-OFDM” in the uplink or downlink, and discrete Fourier transform spread OFDM “DFT-S-OFDM” in the uplink.

The memory/storage 1206 may include one or more non-transitory, computer-readable media that includes instructions (for example, communication protocol stack 1224) that may be executed by one or more of the processors 1202 to cause the UE 1200 to decode the data of the various RLC layer data configurations described herein, such as in relation to FIGS. 2-11. The memory/storage 1206 include any type of volatile or non-volatile memory that may be distributed throughout the UE 1200. In some embodiments, some of the memory/storage 1206 may be located on the processors 1202 themselves (for example, L1 and L2 cache), while other memory/storage 1206 is external to the processors 1202 but accessible thereto via a memory interface. The memory/storage 1206 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1204 may include transceiver circuitry and radio frequency front module (RFEM) that allows the UE 1200 to communicate with other devices over a radio access network. The RF interface circuitry 1204 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 1216 and proceed to filter and amplify (with a low-noise amplifier) the signal. The signal may be provided to a receiver of the transceiver that downconverts the RF signal into a baseband signal that is provided to the baseband processor of the processors 1202.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1216.

In various embodiments, the RF interface circuitry 1204 may be configured to transmit/receive signals in a manner compatible with NR access technologies.

The antenna 1216 may include antenna elements to convert electrical signals into radio waves to travel through the air and to convert received radio waves into electrical signals. The antenna elements may be arranged into one or more antenna panels. The antenna 1216 may have antenna panels that are omnidirectional, directional, or a combination thereof to enable beamforming and multiple input, multiple output communications. The antenna 1216 may include microstrip antennas, printed antennas fabricated on the surface of one or more printed circuit boards, patch antennas, phased array antennas, etc. The antenna 1216 may have one or more panels designed for specific frequency bands including bands in FR1 or FR2.

The user interface 1208 includes various input/output (I/O) devices designed to enable user interaction with the UE 1200. The user interface 1208 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1200.

The sensors 1210 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1212 may include software and hardware elements that operate to control devices that are embedded in the UE 1200, attached to the UE 1200, or otherwise communicatively coupled with the UE 1200. The driver circuitry 1212 may include individual drivers allowing other components to interact with or control various input/output (I/O) devices that may be present within, or connected to, the UE 1200. For example, driver circuitry 1212 may include a display driver to control and allow access to a display device, a touchscreen driver to control and allow access to a touchscreen interface, sensor drivers to obtain sensor readings of sensor circuitry and control and allow access to sensor circuitry, drivers to obtain actuator positions of electro-mechanic components or control and allow access to the electro-mechanic components, a camera driver to control and allow access to an embedded image capture device, audio drivers to control and allow access to one or more audio devices.

The PMIC 1214 may manage power provided to various components of the UE 1200. In particular, with respect to the processors 1202, the PMIC 1214 may control power-source selection, voltage scaling, battery charging, or DC-to-DC conversion.

In some embodiments, the PMIC 1214 may control, or otherwise be part of, various power saving mechanisms of the UE 1200 including DRX as discussed herein. A battery 1218 may power the UE 1200, although in some examples the UE 1200 may be mounted deployed in a fixed location and may have a power supply coupled to an electrical grid. The battery 1218 may be a lithium ion battery, a metal-air battery, such as a zinc-air battery, an aluminum-air battery, a lithium-air battery, and the like. In some implementations, such as in vehicle-based applications, the battery 1218 may be a typical lead-acid automotive battery.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes a method having operations including receiving, from a transmitter, a transport block comprising medium access control (MAC) subheader fields and data units, the transport block being divided into code block groups, a beginning of each code block group in the transport block comprising an alignment with a beginning of a respective MAC subheader field in the transport block; and based on the alignment, decoding the code block groups of the transport block.

Example 2 may include the method described in example 1, further comprising: determining that a code block group, of the code block groups, is successfully decoded; and sending the decoded code block group to a higher layer, the sending being independent of decoding the transport block in entirety.

Example 3 may include the method described in any of examples 1-2, further comprising: while sending the decoded block group to the higher layer, performing Hybrid Automatic Repeat Request (HARD) retransmission for another code block group that is not successfully decoded.

Example 4 may include the method described in any of examples 1-3, wherein the transport block includes padding between a data unit and a subsequent MAC subheader, the padding enabling the alignment between the beginning of a code block group in the transport block and the beginning of the respective MAC subheader field in the transport block.

Example 5 may include the method described in any of examples 1-4, wherein the code block groups each comprise one or more code blocks, a code block representing a data packet that is encoded or decoded for transmitting data in the transport block.

Example 6 may include the method described in any of examples 1-5, wherein the code block groups each comprise a same number of code blocks.

Example 11 may include the method described in any of examples 1-7, wherein a first code block group of the code block groups comprises a first number of code blocks, wherein a second code block group comprises a second number of code blocks, and wherein the first number is different from the second number.

Example 8 may include the method described in any of examples 1-8, wherein the first number is configured to reduce a padding required to align the beginning of each code block group in the transport block being with the beginning of the respective MAC subheader field.

Example 9 may include the method described in any of examples 1-9, wherein the first number is configured to enable the first code block group to include a first data unit that a larger than a second data unit of the second code block group.

Example 10 may include the method described in any of examples 1-9, wherein a mapping of code blocks to respective code block groups is configured by the transmitter depending on a number of the data units of the transport block, a size of the data units of the transport block, or both the number and the size of the data units.

Example 11 may include the method described in any of examples 1-10, further comprising receiving downlink control information (DCI) that specifies a configuration of the transport block, the configuration indicating the alignment of the beginning of each code block group in the transport block with the beginning of a respective MAC subheader field in the transport block.

Example 12 may include the method described in any of examples 1-11, further comprising receiving downlink control information (DCI) specifying mask data, the mask data indicating a number of code blocks for each code block group and an order for the code block groups.

Example 13 includes the method described in any of examples 1-12, further comprising: decoding, for a code block group, a mode indicator bit, the mode indicator bit indicating whether the code block group is aligned with a corresponding MAC subheader.

Example 14 includes the method described in any of examples 1-13, further comprising: receiving mode indicator data in downlink control information (DCI), the mode indicator data indicating, for one or more code blocks of the transport block, whether a given code block group is aligned with a corresponding MAC subheader.

Example 15 includes the method described in any of examples 1-14, wherein MAC control elements (CEs) are interspersed in the transport block among the MAC subheaders and the data units.

Example 16 includes the method described in any of examples 1-15, wherein a first code block group of the code block groups comprises a first number of code blocks, wherein a second code block group comprises a second number of code blocks, and wherein the first number is different from the second number; wherein MAC control elements (CEs) are interspersed in the transport block among the MAC subheaders and the data units; and wherein the first number and the second number are configured based on respective lengths of the data units, and wherein the MAC CEs are interspersed based on padding space available in one or more of the first code block group or the second code block group, the padding space enabling the alignment of the beginning of each code block group in the transport block with the beginning of a respective MAC subheader field in the transport block.

Example 17 includes the method described in any of examples 1-16, further comprising receiving downlink control information (DCI) specifying mask data, the mask data indicating a number of code blocks for each code block group and an order for the code block groups.

Example 18 includes the method described in any of examples 1-17, wherein the transport block is received through a radio link control (RLC) layer.

Example 19 includes the method described in any of examples 1-18, wherein the data units comprise service data units (SDUs).

Example 20 includes the method described in any of examples 1-19, wherein the data units comprise protocol data units (PDUs).

Example 21 includes the method described in any of examples 1-20, wherein the transport block is configured for an uplink communication scenario.

Example 22 includes the method described in any of examples 1-21, wherein the transport block is configured for a downlink communication scenario.

Example 23 includes the method described in any of examples 1-22, wherein the transmitter is part of a base station, and the receiver is part of a user equipment.

Example 24 includes the method described in any of examples 1-23, wherein the transmitter is part of a user equipment, and the receiver is part of a base station.

Example 25 includes a method performed by a transmitter, the method comprising: configuring a transport block comprising medium access control (MAC) subheader fields and data units, the transport block being divided into code block groups, a beginning of each code block group in the transport block comprising an alignment with a beginning of a respective MAC subheader field in the transport block; and transmitting the configured transport block to a receiver.

Example 26 includes the method described in example 25, further comprising adding a padding between a data unit and a subsequent MAC subheader, the padding enabling the alignment between the beginning of a code block group in the transport block and the beginning of the respective MAC subheader field in the transport block.

Example 27 includes the method described in any of examples 25-26,

Example 28 includes the method described in any of examples 25-27, wherein the code block groups each comprise one or more code blocks, a code block representing a data packet that is encoded or decoded for transmitting data in the transport block.

Example 29 includes the method described in any of examples 25-28, wherein the code block groups each comprise a same number of code blocks.

Example 30 includes the method described in any of examples 25-29, wherein a first code block group of the code block groups comprises a first number of code blocks, wherein a second code block group comprises a second number of code blocks, and wherein the first number is different from the second number.

Example 31 includes the method described in any of examples 25-30, further comprising adjusting a number of code blocks for a particular code block group based on a size of a particular data unit include in the code block group.

Example 32 includes the method described in any of examples 25-31 sending downlink control information (DCI) to the receiver, the DCI specifying a mapping between the code block groups and the data units; and mapping wherein a mapping of code blocks to respective code block groups is performed dynamically by the transmitter.

Example 33 includes the method described in any of examples 25-32, further comprising sending downlink control information (DCI) that specifies a configuration of the transport block, the configuration indicating the alignment of the beginning of each code block group in the transport block with the beginning of a respective MAC subheader field in the transport block.

Example 34 includes the method described in any of examples 25-33, wherein MAC control elements (CEs) are interspersed in the transport block among the MAC subheaders and the data units.

Example 35 includes the method described in any of examples 25-33, further comprising sending downlink control information (DCI) specifying mask data, the mask data indicating a number of code blocks for each code block group and an order for the code block groups.

Example 36 includes the method described in any of examples 25-35, further comprising adding a mode indicator bit to a code block group, the mode indicator bit indicating whether the code block group is aligned with a corresponding MAC subheader.

Example 37 includes the method described in any of examples 25-36, further comprising sending a mode indicator data to the receiver in downlink control information (DCI), the mode indicator data indicating, for one or more code blocks, whether a given code block group is aligned with a corresponding MAC subheader.

Example 38 includes the method described in any of examples 25-37, wherein the transport block is received through a radio link control (RLC) layer.

Example 39 includes the method described in any of examples 25-38, wherein the data units comprise service data units (SDUs).

Example 40 includes the method described in any of examples 25-39, wherein the data units comprise protocol data units (PDUs).

Example 41 includes the method described in any of examples 25-40, wherein the transport block is configured for an uplink communication scenario.

Example 42 includes the method described in any of examples 25-41, wherein the transport block is configured for a downlink communication scenario.

Example 43 includes the method described in any of examples 25-42, wherein the transmitter is part of a base station, and the receiver is part of a user equipment.

Example 44 includes the method described in any of examples 25-43, wherein the transmitter is part of a user equipment, and the receiver is part of a base station.

Example 45 may include one or more non-transitory computer-readable media including instructions to cause an electronic device, upon execution of the instructions by one or more processors of the electronic device, to perform one or more elements of a method described in or related to any of examples 1-44, or any other method or process described herein.

Example 46 may include an apparatus including logic, modules, or circuitry to perform one or more elements of a method described in or related to any of examples 1-44, or any other method or process described herein.

Example 47 may include a method, technique, or process as described in or related to any of examples 1-44, or portions or parts thereof.

Example 48 may include an apparatus including: one or more processors and one or more computer-readable media including instructions that, when executed by the one or more processors, cause the one or more processors to perform the method, techniques, or process as described in or related to any of examples 1-44, or portions thereof.

Example 49 may include a signal as described in or related to any of examples 1-44, or portions or parts thereof.

Example 50 may include a datagram, information element, packet, frame, segment, PDU, or message as described in or related to any of examples 1-44, or portions or parts thereof, or otherwise described in the present disclosure.

Example 51 may include a signal encoded with data as described in or related to any of examples 1-44, or portions or parts thereof, or otherwise described in the present disclosure.

Example 52 may include a signal encoded with a datagram, IE, packet, frame, segment, PDU, or message as described in or related to any of examples 1-44, or portions or parts thereof, or otherwise described in the present disclosure.

Example 53 may include an electromagnetic signal carrying computer-readable instructions, wherein execution of the computer-readable instructions by one or more processors is to cause the one or more processors to perform the method, techniques, or process as described in or related to any of examples 1-44, or portions thereof.

Example 54 may include a computer program including instructions, wherein execution of the program by a processing element is to cause the processing element to carry out the method, techniques, or process as described in or related to any of examples 1-44, or portions thereof. The operations or actions performed by the instructions executed by the processing element can include the methods of any one of examples 1-44.

Example 55 may include a signal in a wireless network as shown and described herein.

Example 56 may include a method of communicating in a wireless network as shown and described herein.

Example 57 may include a system for providing wireless communication as shown and described herein. The operations or actions performed by the system can include the methods of any one of examples 1-44.

Example 58 may include a device for providing wireless communication as shown and described herein. The operations or actions performed by the device can include the methods of any one of examples 1-44.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A method comprising:
receiving, from a transmitter, a transport block comprising medium access control (MAC) subheader fields and data units, the transport block being divided into code block groups, a beginning of each code block group in the transport block comprising an alignment with a beginning of a respective MAC subheader field in the transport block; and
based on the alignment, decoding the code block groups of the transport block.

2. The method of claim 1, further comprising:
determining that a code block group, of the code block groups, is successfully decoded; and
sending the decoded code block group to a higher layer, the sending being independent of decoding the transport block in entirety.

3. The method of claim 2, further comprising:
while sending the decoded block group to the higher layer, performing Hybrid Automatic Repeat Request (HARD) retransmission for another code block group that is not successfully decoded.

4. The method of claim 1, wherein the transport block includes padding between a data unit and a subsequent MAC subheader, the padding enabling the alignment between the beginning of a code block group in the transport block and the beginning of the respective MAC subheader field in the transport block.

5. The method of claim 1, wherein the code block groups each comprise one or more code blocks, a code block representing a data packet that is encoded or decoded for transmitting data in the transport block.

6. The method of claim 5, wherein the code block groups each comprise a same number of code blocks.

7. The method of claim 5, wherein a first code block group of the code block groups comprises a first number of code blocks, wherein a second code block group comprises a second number of code blocks, and wherein the first number is different from the second number.

8. The method of claim 7, wherein the first number is configured to reduce a padding required to align the beginning of each code block group in the transport block being with the beginning of the respective MAC subheader field.

9. The method of claim 7, wherein the first number is configured to enable the first code block group to include a first data unit that is larger than a second data unit of the second code block group.

10. The method of claim 5, wherein a mapping of code blocks to respective code block groups is configured by the transmitter depending on a number of the data units of the transport block, a size of the data units of the transport block, or both the number and the size of the data units.

11. The method of claim 1, further comprising receiving downlink control information (DCI) that specifies a configuration of the transport block, the configuration indicating the alignment of the beginning of each code block group in the transport block with the beginning of a respective MAC subheader field in the transport block.

12. The method of claim 1, further comprising receiving downlink control information (DCI) specifying mask data, the mask data indicating a number of code blocks for each code block group and an order for the code block groups.

13. The method of claim 1, further comprising:
decoding, for a code block group, a mode indicator bit, the mode indicator bit indicating whether the code block group is aligned with a corresponding MAC subheader.

14. The method of claim 1, further comprising:
receiving mode indicator data in downlink control information (DCI), the mode indicator data indicating, for one or more code blocks of the transport block, whether a given code block group is aligned with a corresponding MAC subheader.

15. The method of claim 1, wherein MAC control elements (CEs) are interspersed in the transport block among the MAC subheaders and the data units.

16. The method of claim 1, wherein a first code block group of the code block groups comprises a first number of code blocks, wherein a second code block group comprises a second number of code blocks, and wherein the first number is different from the second number;
wherein MAC control elements (CEs) are interspersed in the transport block among the MAC subheaders and the data units; and
wherein the first number and the second number are configured based on respective lengths of the data units, and wherein the MAC CEs are interspersed based on padding space available in one or more of the first code block group or the second code block group, the padding space enabling the alignment of the beginning of each code block group in the transport block with the beginning of a respective MAC subheader field in the transport block.

17. The method of claim 1, further comprising receiving downlink control information (DCI) specifying mask data, the mask data indicating a number of code blocks for each code block group and an order for the code block groups.

18. The method of claim 1, wherein the transport block is received through a PHY layer.

19. A method performed by a transmitter, the method comprising:
configuring a transport block comprising medium access control (MAC) subheader fields and data units, the transport block being divided into code block groups, a beginning of each code block group in the transport block comprising an alignment with a beginning of a respective MAC subheader field in the transport block; and
transmitting the configured transport block to a receiver.

20. One or more baseband processors configured to perform operation comprising:
receiving, from a transmitter, a transport block comprising medium access control (MAC) subheader fields and data units, the transport block being divided into code block groups, a beginning of each code block group in the transport block comprising an alignment with a beginning of a respective MAC subheader field in the transport block; and
based on the alignment, decoding the code block groups of the transport block.
